(19) United States
(12) Patent Application Publication
(10) Pub. No.: US 2019/0392556 A1
(43) Pub. Date: Dec. 26, 2019

(54) METHOD, CHIP, PROCESSOR, COMPUTER SYSTEM, AND MOBILE DEVICE FOR IMAGE PROCESSING

(71) Applicant: SZ DJI TECHNOLOGY CO., LTD., Shenzhen (CN)

(72) Inventors: Yao Zhao, Shenzhen (CN); Zhao Yan, Shenzhen (CN); Kang Yang, Shenzhen (CN)

(21) Appl. No.: 16/564,885

(22) Filed: Sep. 9, 2019

Related U.S. Application Data
(63) Continuation of application No. PCT/CN2017/076409, filed on Mar. 13, 2017.

(51) Int. Cl. G06T 3/40; G06T 5/00; G06F 17/16

(52) U.S. Cl. CPC G06T 3/4007; G06F 17/16; G06T 5/00

(57) ABSTRACT

The present disclosure provides an image processing method. The method includes reading R rows of data of the image into a first storage buffer, R is an integer greater than 1; upsampling and filtering the R rows of data to obtain M rows of processed data, M is the upsampling multiple in the upsampling and filtering process, and M is an integer greater than 1. The method further includes reading a next row of data of the image into the first storage buffer after processing the R rows of data, the next row of data and the original R−1 rows of data in the first storage buffer are used as the R rows of data for the next upsampling and filtering process; and outputting the M rows of processed data.

### CROSS-REFERENCE TO RELATED APPLICATION

This application is a continuation application of International Application No. PCT/CN2017/076409, filed on Mar. 13, 2017, the entire contents of which are incorporated herein by reference.

### TECHNICAL FIELD

The present disclosure relates to the field of image processing, more specifically, to a method, a chip, a processor, a computer system, and a mobile device for image processing.

### BACKGROUND

The upsampling and filtering process of an image is generally divided into two stages, that is, the image may be first upsampled to obtain an enlarged intermediate image, and then the upsampled intermediate image may be filtered to obtain a resulting image.

The process mentioned above requires buffering the image before the upsampling and the intermediate image after the upsampling, that is, both upsampling and filtering need to be buffered. For example, assuming the pixel width of the upsampled intermediate image is the same as the original image, the upsampling may require a W*2 line buffer, where W may be the width of the original image, that is, the number of columns. Further, the filtering of the intermediate image after the upsampling may require a 2W*K line buffer, where 2W may be the width of the upsampled intermediate image and K may be the filter kernel width. Taking K=5 as an example, the upsampling may require a line buffer of 2*W depth, the filtering may require a line buffer of 10*W depth, the process may take a total of 12*W depth of line buffer, and more than 80% of the storage resources may be used in buffering the upsampled intermediate image. Further, if the pixel width of the upsampled intermediate image is larger than the original image, the consumption of the storage resources will increase significantly.

Therefore, reducing the consumption of the storage resources has become a challenge in image processing methods.

### SUMMARY

The embodiments of the present disclosure provide a method, a chip, a processor, a computer system, and a mobile device for image processing, which may reduce the consumption of the storage resources.

One aspect of the present disclosure provides an image processing method. The method includes reading R rows of data of the image into a first storage buffer, R is an integer greater than 1; upsampling and filtering the R rows of data to obtain M rows of processed data, M is the upsampling multiple in the upsampling and filtering process, and M is an integer greater than 1. The method further includes reading a next row of data of the image into the first storage buffer after processing the R rows of data, the next row of data and the original R−1 rows of data in the first storage buffer are used as the R rows of data for the next upsampling and filtering process; and outputting the M rows of processed data.

Another aspect of the present disclosure provides a chip. The chip includes a processing circuit and a first storage buffer. The processing circuit is configured to perform: reading R rows of data of the image into the first storage buffer, R is an integer greater than 1; upsampling and filtering the R rows of data to obtain M rows of processed data, M is the upsampling multiple in the upsampling and filtering process, and M is an integer greater than 1; reading a next row of data of the image into the first storage buffer after processing the R rows of data, the next row of data and the original R−1 rows of data in the first storage buffer are used as the R rows of data for the next upsampling and filtering process; and outputting the M rows of processed data.

Another aspect of the present disclosure provides an image processing method. The method includes upsampling and filtering an area of R*R of the image to obtain an area of M*M; upsampling to obtain an area of (K+M−1)*(K+M−1); filtering with a kernel width of K on the area of (K+M−1)*(K+M−1) to obtain an area of M*M, wherein R, M, and K are integers greater than 1; and outputting the area of M*M.

Another aspect of the present disclosure provides an image processing method for an image of R*R. The method includes upsampling to obtain an area of (K+M−1)*(K+M−1), K being a kernel width; filtering with the kernel width of K on the area of (K+M−1)*(K+M−1) to obtain an area of M*M, wherein R, M, and K are integers greater than 1; and outputting the area of M*M.

The technical solution provided in the embodiments of the present disclosure may be used to perform a one-time upsampling and filtering process on R rows of data of an image to obtain M lines of processed data, where R may be an integer greater than 2 and M may be an upsampling multiple. The technical solution provided does not require the buffering of the upsampled intermediate image, thereby reducing the storage resources consumption.

### BRIEF DESCRIPTION OF THE DRAWINGS

To describe the technical solutions in the embodiments of the present invention more clearly, the following briefly introduces the accompanying drawings needed to describe the embodiments of the present disclosure. The accompanying drawings in the following description show merely some embodiments of the present disclosure, and a person of ordinary skill in the art may still derive other drawings from these accompanying drawings without creative efforts.

FIG. 1 is an architectural diagram of a technical solution being implemented according to an embodiment of the present disclosure;

FIG. 2 is a processing architecture diagram of a technical solution according to an embodiment of the present disclosure;

FIG. 3 is a schematic structural diagram of a mobile device according to an embodiment of the present disclosure;

FIG. 4 is a schematic flowchart of an image processing method according to an embodiment of the present disclosure;

FIG. 5 is a processing architecture diagram of a technical solution according to another embodiment of the present disclosure;

FIG. 6 is a schematic flowchart of an image processing method according to another embodiment of the present disclosure;

FIG. 7 is a schematic block diagram of a chip according to an embodiment of the present disclosure;

FIG. 8 is a schematic block diagram of a chip according to another embodiment of the present disclosure;

FIG. 9 is a schematic block diagram of a chip according to yet another embodiment of the present disclosure;

FIG. 10 is a schematic block diagram of a computer system according to an embodiment of the present disclosure.

### DETAILED DESCRIPTION OF THE EMBODIMENTS

The technical solution provided in the embodiments of the present disclosure will be described below with reference to the accompanying drawings.

It should be understood that the specific examples provided herein are merely used to help a person skilled in the art to have a better understanding of the embodiments of the present disclosure, and are not intended to limit the scope of the embodiments of the present disclosure.

It should be understood that the formulas provided in the embodiments of the present disclosure are only examples and are not intended to limit the scope of the embodiments of the present disclosure. The formulas may be modified, and such modifications are also within the scope of the present disclosure.

It should be understood that, in various embodiments of the present disclosure, values of sequence numbers of the processes do not indicate execution sequences, and the execution sequence of each process should be determined according to a function and inherent logic thereof, but should not form any limit to implementation processes of the embodiments of the present disclosure.

It should be understood that the various embodiments described in the present disclosure may be implemented separately or in combination, and the embodiments of the present disclosure are not limited thereto.

The technical solution provided in the embodiments of the present disclosure may be used to perform a one-time upsampling and filtering process on image data, that is, the upsampling and the filtering process may be completed at once, so it may not be necessary to buffer the upsampled intermediate image, thereby reducing the storage resources consumption.

The upsampling and filtering process provided in the embodiments of the present disclosure may combine the processing logics of the upsampling process and the filtering process, that is, the two processing logics may be realized by one process. It should be understood that in the present disclosure, for the convenience of description, the processing logic of the upsampling process and the filtering process are separately described, but it should not be construed as being processes.

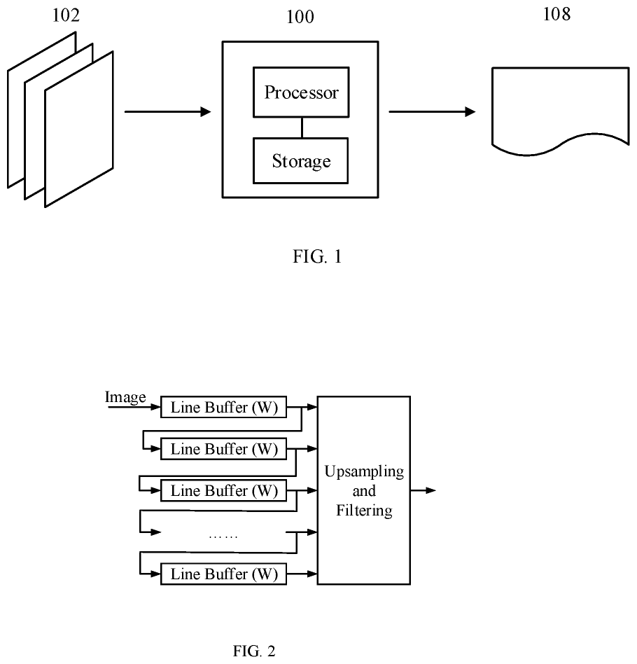

FIG. 1 is an architectural diagram of a technical solution being implemented according to an embodiment of the present disclosure.

As shown in FIG. 1, a system 100 may be used to receive data to be processed 102, perform an upsampling and filtering process on the data to be processed 102, generate processed data 108, and output the processed data 108. In some embodiments, the components in the system 100 may be implemented by one or more processors, which may be processors in a computing device or processors in a mobile device (e.g., an unmanned aerial vehicle). The processor may be any type of processor, which is not limited in the embodiments of the present disclosure. In some embodiments, the process may be a chip consisting of a buffer and a processing circuitry (which may be referred to as a processing unit). In some embodiments, the system 100 may include one or more storage devices. The storage device may be used to store computer executable instructions and data. For example, the computer system used to implement the technical solution provided in the embodiments of the present disclosure may be used to execute computer executable instructions to handle data to be processed 102, processed data 108, etc. For example, the storage device may include a buffer or a memory. Further, the storage device may be any type of storage, which is not limited in the embodiments of the present disclosure.

The data to be processed 102 may include data of an image, or other similar multimedia data. In some embodiments, the data to be processed 102 may include sensory data from sensors, which may be visual sensors (e.g., cameras, infrared sensor, etc.), near field sensors (e.g., ultrasonic sensors, radars, etc.), location sensors, etc. In some cases, the data to be processed 102 may include information from a user, such as biometric information, which may include facial features, fingerprint scans, retinal scans, DNA sampling, etc.

FIG. 2 is a processing architecture diagram of a technical solution according to an embodiment of the present disclosure. As shown in FIG. 2, parts of the line data of the image may be input into the buffer, which may include a plurality of line buffers. Then the upsampling and filtering process provided in the embodiments of the present disclosure may be performed on the data in the buffer. In particular, in the upsampling and filtering process, after the upsampling process is performed on a part of the data in the buffer, the upsampling result of the part of the data may be filtered immediately. Subsequently, the same upsampling and filtering processing logic may be repeated on another part of the data in the buffer. This is different than the conventional image processing method in which all the data of the image may be sequentially upsampled, then the results of the upsampling process of all the data in the image may go through the filtering process in batches. Using the process provided in the present embodiment, the results of the upsampling process of all the data of the image may not need to be buffered, thereby reducing the consumption of the storage resources.

In some embodiments, the buffer in the various embodiments of the present disclosure may be a line buffer, but is not limited thereto.

In some embodiments, the mobile device, which may be referred to as a portable device, may process data using the technical solution provided in the embodiments of the present disclosure. The mobile device may be an Unmanned Aerial Vehicle (UAV), an unmanned ship, a robot, etc., but is not limited thereto.

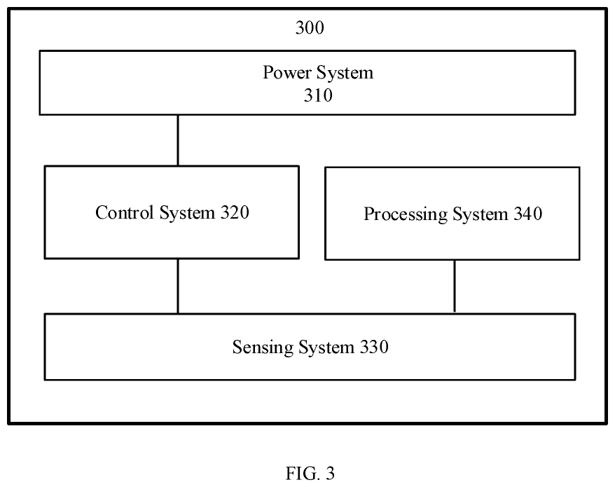

FIG. 3 is a schematic structural diagram of a mobile device 300 according to an embodiment of the present disclosure.

As shown in FIG. 3, the mobile device 300 may include a power system 310, a control system 320, a sensing system 330, and a processing system 340.

The power system 310 may be used to power the mobile device 300.

Taking the UAV as an example. The power system of the UAV may include an Electronic Speed Controller (ESC), a propeller, and a motor corresponding to the propeller. The motor may be connected between the ESC and the propeller, and the motor and the propeller may be disposed on a corresponding arm. Further, the ESC may be used to receive a driving signal generated by the control system 320 and provide a driving current to the motor based on the driving signal to control the rotation speed of the motor. Furthermore, the motor may be used to drive the propeller to rotate to power the UAV's flight.

The sensing system 330 may be used to detect the position information of the mobile device 300, that is, the location information and the status information of the mobile device 300 in space, such as the three-dimensional location, the three-dimensional angle, the three-dimensional velocity, the three-dimensional acceleration, the three-dimensional angular velocity, etc. The sensing system 330 may include, for example, one or more of a gyroscope, an electronic compass, an Inertial Measurement Unit (IMU), a vision sensor, a Global Positioning System (GPS), a barometer, an airspeed meter, etc.

In the embodiments of the present disclosure, the sensing system 330 may also be used to acquire images, i.e., the sensing system 330 may include sensors for acquiring images, such as cameras and the like.

The control system 320 may be used to control the movement of the mobile device 300. The control system 320 may control the mobile device 300 based on a pre-programmed computer executable instructions. For example, the control system 320 may control the movement of the mobile device 300 based on the position information of the mobile device 300 detected by the sensing system 330. Further, the control system 320 may also control the mobile device 300 based on a control signal from a remote control.

The processing system 340 may process the images acquired by the sensing system 330. For example, the processing system 340 may perform the upsampling and filtering process on the image data.

The processing system 340 may be the system 100 in FIG. 1, or the processing system 340 may include the system 100 of FIG. 1.

It should be understood that the categorization and the naming convention of the various parts of the mobile device 300 mentioned above are merely exemplary and are not to be construed as limiting the embodiments of the present disclosure.

It should also be understood that the mobile device 300 may also include other parts not shown in FIG. 3, which are not limited by the embodiments of the present disclosure.

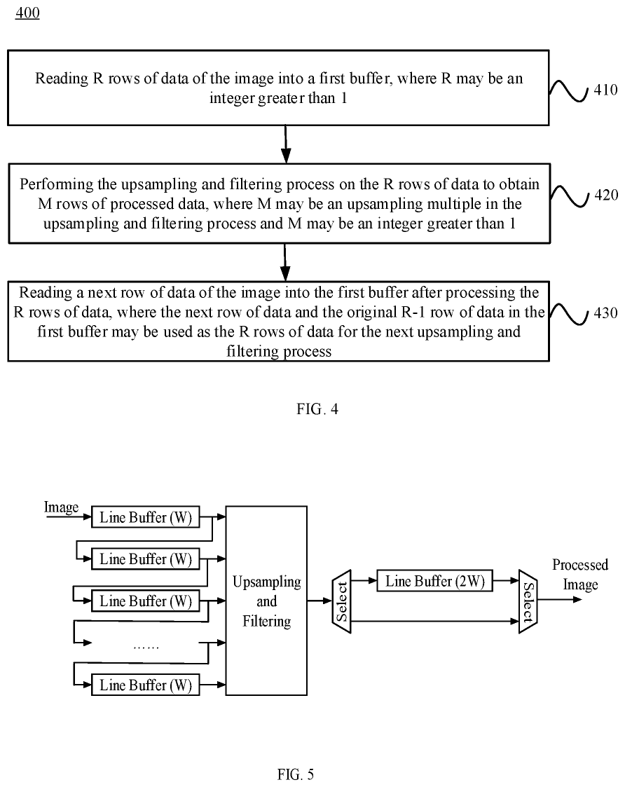

FIG. 4 is a schematic flowchart of an image processing method 400 according to an embodiment of the present disclosure. The method 400 may be performed by the system 100 shown in FIG. 1 or the mobile device 300 shown in FIG. 3. More specifically, when the method 400 is performed by the mobile device 300, it may be performed by the processing system 340 shown in FIG. 3. The method 400 may include the following steps:

Step 410, reading R rows of data of the image into a first buffer, where R may be an integer great than 1.

In the embodiments of the present disclosure, a plurality of rows of data of the image may be read into the first buffer for the subsequent upsampling and filtering process.

In some embodiments, the number of rows R of the simultaneously processed data may be associated with the upsampling multiple M and the filter kernel width K.

In one embodiment of the present disclosure, the R may satisfy the following condition: an area of (K+M−1)*(K+M−1) may be obtained after upsampling an area of R*R of the R rows of data with M multiple, where K may be the filter kernel width in the upsampling and filtering process.

For example, R may satisfy the following formula (1)

$$R = ⌈ \frac{K + M - 1}{M} ⌉ + 1 \qquad ( 1 )$$

For example, if the upsampling multiple M is 2 and the filter kernel width is 5, then R may be 4. That is, in this case, the upsampling and filtering process may be performed on 4 rows of data of the image at once.

Step 420: performing the upsampling and filtering process on the R rows of data to obtain M rows of processed data, where M may be an upsampling multiple in the upsampling and filtering process and M may be an integer greater than 1.

After R rows of data is read into the first buffer, the upsampling and filtering process may be performed in the R rows of data to obtain M rows of processed data. For example, when the upsampling multiple M is 2 and the filter kernel width K is 5, 4 rows of data of the image may be read into the first buffer, and the upsampling and filtering process may be performed to obtain 2 rows of processed data.

In some embodiments, the upsampling and filtering process performed on the R rows of data may use the area of R*R as a processing unit. Each area of R*R may include R*R data, and each process may move one column. That is, the next area of R*R may include the last R−1 columns in the last area of R*R and a new column. More specifically, each area of R*R of the R lines of data may be sequentially processed as follows:

For each area of R*R, the area of (K+M−1)*(K+M−1) may be obtained by using the upsampling process.

For the area of (K+M−1)*(K+M−1), the filtering process with the kernel width K may be performed to obtain an area of M*M. In particular, the area of M*M may be the Mth column of the M rows of the processed data.

That is, the area of M*M may be obtained by performing the process mentioned above on the area of R*R, and M rows of processed data may be obtained by performing the process mentioned above on all the area of R*R of the R rows of data.

For example, assuming the pixel of the image may be represented by Aᵤ, where R may be 4, and W may be 10. For the first 4 rows, the first 4*4 area may be:

| | | | |
|---|---|---|---|
| A₀₀ | A₀₁ | A₀₂ | A₀₃ |
| A₁₀ | A₁₁ | A₁₂ | A₁₃ |
| A₂₀ | A₂₁ | A₂₂ | A₂₃ |
| A₃₀ | A₃₁ | A₃₂ | A₃₃ |

The second 4*4 area may be:

| | | | |
|---|---|---|---|
| A₀₁ | A₀₂ | A₀₃ | A₀₄ |
| A₁₁ | A₁₂ | A₁₃ | A₁₄ |
| A₂₁ | A₂₂ | A₂₃ | A₂₄ |
| A₃₁ | A₃₂ | A₃₃ | A₃₄ |

The second 4*4 area may be:

| | | | |
|---|---|---|---|
| A₀₂ | A₀₃ | A₀₄ | A₀₅ |
| A₁₂ | A₁₃ | A₁₄ | A₁₅ |
| A₂₂ | A₂₃ | A₂₄ | A₂₅ |
| A₃₂ | A₃₃ | A₃₄ | A₃₅ |

The subsequent 4*4 areas may be obtained using the same process.

The processing of an area of R*R will be described in detail below. It should be understood that in the embodiments of the present disclosure, after processing the area of R*R, the area of M*M and the area of (K+M−1)*(K+M−1) obtained are used merely for the convenience of describing the processing logic of the embodiments of the present disclosure as they are merely the logical intermediates and may not appear in some embodiments.

For the area of R*R, the area of (K+M−1)*(K+M−1) may be obtained by perform the upsampling process, and the area of (K+M−1)*(K+M−1) may include M*M numbers of K*K areas. In particular, the selection of the areas of K*K may be performed by moving one row or one column for each of the M*M numbers of K*K areas of the area of (K+M−1)*(K+M−1) area. A piece of data of the area of M*M may be obtained by performing the filtering process with the kernel width K, and M*M pieces of data of the area of M*M may be obtained by the M*M numbers of K*K areas.

In the process mentioned above, an area of K*K may be processed by using the filtering process with the kernel width K to obtain a data. For example, each of the data in the area of K*K may be multiplied by a corresponding element in the K*K filter matrix and summed. Hence, M*M numbers of K*K areas may obtain M*M numbers of data, that is, the area of M*M may be obtained.

For example, when R is 4, M is 2, and K is 5, the upsampling of an area of 4*4 may result in an area of 6*6. Using the following area of 4*4 as an example,

| | | | |
|---|---|---|---|
| A₀₀ | A₀₁ | A₀₂ | A₀₃ |
| A₁₀ | A₁₁ | A₁₂ | A₁₃ |
| A₂₀ | A₂₁ | A₂₂ | A₂₃ |
| A₃₀ | A₃₁ | A₃₂ | A₃₃ |

After upsampling, the following area of 6*6 may be obtained,

| | | | | | |
|---|---|---|---|---|---|
| B₀₀ | B₀₁ | B₀₂ | B₀₃ | B₀₄ | B₀₅ |
| B₁₀ | B₁₁ | B₁₂ | B₁₃ | B₁₄ | B₁₅ |
| B₂₀ | B₂₁ | B₂₂ | B₂₃ | B₂₄ | B₂₅ |
| B₃₀ | B₃₁ | B₃₂ | B₃₃ | B₃₄ | B₃₅ |
| B₄₀ | B₄₁ | B₄₂ | B₄₃ | B₄₄ | B₄₅ |
| B₅₀ | B₅₁ | B₅₂ | B₅₃ | B₅₄ | B₅₅ |

In particular, the following upsampling process uses a linear interpolation as an example, then,

B₀₀=A₀₀

B₁₀=(A₀₀+A₁₀)/2

B₂₀=A₁₀

B₃₀=(A₁₀+A₂₀)/2

B₄₀=A₂₀

B₅₀=(A₂₀+A₃₀)/2

B₀₁=(A₀₀+A₀₁/2

B₁₁=(A₀₀+A₁₀+A₀₁+A₁₁)/4

B₂₁=(A₁₀+A₁₁)/2

B₃₁=(A₁₀±A₂₀±A₁₁±A₂₁)/4

B₄₁=(A₂₀±A₂₁)/2

B₅₁=(A₂₀+A₃₀+A₂₁+A₃₁)/4

The area of 6*6 may be divided into 4 (i.e., 2*2) 5*5 areas, namely:

| | | | | |
|---|---|---|---|---|
| B₀₀ | B₀₁ | B₀₂ | B₀₃ | B₀₄ |
| B₁₀ | B₁₁ | B₁₂ | B₁₃ | B₁₄ |
| B₂₀ | B₂₁ | B₂₂ | B₂₃ | B₂₄ |
| B₃₀ | B₃₁ | B₃₂ | B₃₃ | B₃₄ |
| B₄₀ | B₄₁ | B₄₂ | B₄₃ | B₄₄ |
| B₁₀ | B₁₁ | B₁₂ | B₁₃ | B₁₄ |
| B₂₀ | B₂₁ | B₂₂ | B₂₃ | B₂₄ |
| B₃₀ | B₃₁ | B₃₂ | B₃₃ | B₃₄ |
| B₄₀ | B₄₁ | B₄₂ | B₄₃ | B₄₄ |
| B₅₀ | B₅₁ | B₅₂ | B₅₃ | B₅₄ |
| B₀₁ | B₀₂ | B₀₃ | B₀₄ | B₀₅ |
| B₁₁ | B₁₂ | B₁₃ | B₁₄ | B₁₅ |
| B₂₁ | B₂₂ | B₂₃ | B₂₄ | B₂₅ |
| B₃₁ | B₃₂ | B₃₃ | B₃₄ | B₃₅ |
| B₄₁ | B₄₂ | B₄₃ | B₄₄ | B₄₅ |
| B₁₁ | B₁₂ | B₁₃ | B₁₄ | B₁₅ |
| B₂₁ | B₂₂ | B₂₃ | B₂₄ | B₂₅ |
| B₃₁ | B₃₂ | B₃₃ | B₃₄ | B₃₅ |
| B₄₁ | B₄₂ | B₄₃ | B₄₄ | B₄₅ |
| B₅₁ | B₅₂ | B₅₃ | B₅₄ | B₅₅ |

For each of the area of 5*5 mentioned above may be processed by using the filtering process with the kernel width of 5 to obtain a data. For example, each of the data in the area of 5*5 may be multiplied by a corresponding element in the 5*5 filter matrix and summed to obtain a data. Hence, 4 data of the 2*2 area may be obtained through the 4 5*5 areas.

The upsampling and filtering process mentioned above may be performed on the area of R*R to obtain the area of M*M. Further, M rows of processed data may be obtained by performing the upsampling and filtering process mentioned above on all the areas of R*R on the R rows of data.

Step 430, reading a next row of data of the image into the first buffer after processing the R rows of data, where the next row of data and the original R−1 rows of data in the first buffer may be used as the R rows of data for the next upsampling and filtering process.

More specifically, after the R rows of data in the first buffer is processed, a new row of data may be read and combined with the original R−1 rows of data as a new R rows of data for the next upsampling and filtering process. The newly formed R rows of data may be processed using the upsampling and filtering process mentioned above, and so on.

For example, referring to FIG. 2, after processing the original R rows of data, the next row of data of the image may be read, the data in the buffer may be sequentially moved downward, and the newly read row of data and the original R−1 rows of data may be used to form the new R rows of data. The newly formed R rows of data may be processed using the upsampling and filtering process mentioned above, and so on.

In some embodiments, the M rows of processed data obtained after processing the R rows of data using the upsampling and filtering process, a first row of the M rows of the processed data may be outputted first, and the second to Mth rows of the M rows of processed data may be buffered into a second buffer. After outputting the first row of the processed data, the second to Mth rows of the processed data may be sequentially outputted from the second buffer. After outputting the Mth row of the M rows of processed data, the next row of data of the image may be read into the first buffer.

More specifically, the M rows of processed data obtained after processing the R rows of data by using the upsampling and filtering process may be outputted by rows when outputting. Further, no buffering is required for the first row of the processed data, that is, the corresponding data may be obtained and outputted. In particular, the other rows of the processed data may be buffered and sequentially outputted after the first row of the processed data is outputted. For example, referring to the processing architecture diagram shown in FIG. 5. Assuming M is 2, that is, 2 rows of processed data may be obtained after the upsampling and filtering process, the first row may be outputted directly, and the next row may be buffered. After the output of the first row is completed, the next row may be completely buffered in the buffer, the next row in the buffer may be read to continue the output until the output of the next row is completed. The process mentioned above may be repeated and the entire processed image may be outputted by rows.

In some embodiments, two selectors may be used when outputting the M rows of processed data obtained after processing the R rows of data by using the upsampling and filtering process. For example, the M rows of data obtained after the upsampling and filtering process may be inputted into a first selector, the first selector may select one row as a current row of output, and select to place the remaining rows in the line buffer. A second selector may first select to output the current row, then output the remaining rows in the line buffer sequentially. After the second selector finishes outputting the last row of the remaining rows, the first selector may receive a next M rows of data obtained after the upsampling and filtering process, and the process mentioned above may be repeated.

In some embodiments, the outputting the M rows of processed data obtained after processing the R rows of data by using the upsampling and filtering process by rows may be implemented by one selector, or selection processing and the upsampling and filter processing may be performed by a unified processing circuit, which is not limited in the embodiments of the present disclosure.

The technical solution provided in the embodiments of the present disclosure may be used to perform a one-time upsampling and filtering process on R rows of data of an image to obtain M lines of processed data. The technical solution provided does not require the buffering of the upsampled intermediate image, thereby reducing the storage resources consumption.

For example, assuming the upsampling multiple M is 2, the filter kernel width K is 5, the width of the original image is W, and the pixel width of the upsampled image is the same as the pixel width of the original image. Using the conventional image processing method, the upsampling may require a line buffer of 2*W in depth, the filtering may require a line buffer of 10*W in depth, and a total line buffer of 12*W in depth may be required. The technical solution provided in the embodiments of the present disclosure, the upsampling and filtering process may on require a line buffer of 4*W in depth, the buffering of one row of data may require a line buffer of 2*W in depth, and a total line buffer of 6*W in depth may be required. Compared to the conventional image processing method, the technical solution provided in the embodiments of the present disclosure may save 50% in storage resources. Further, if the pixel width of the upsampled image is larger than the pixel width of the original image, only the depth of the line buffer for buffering one row of processed data may be affected, and the consumption of the overall storage resources may not increase significantly. Therefore, the technical solution provided in the embodiments of the present invention can effectively reduce the consumption of storage resources.

In one embodiment, each data element in the image may be the data located at the center of the area of R*R. Therefore, it may be necessary to pad the data located on the outer edges of the four edges of the image (that is, the first row, the last row, the first column, and the last column), so the data located on the edge of the image may also be the data located at the center of the R*R area. In particular, the number of rows and columns needed to pad the outer edges of the image may depend on the value of R.

For example, if the number of columns of the image is W, then the outer edges of the R rows of data may be padded to obtain W number of R*R areas, and M*W columns of M rows of processed data may be obtained by the W number of R*R areas. In particular, the number of columns of the M rows of processed data may be M*W.

It should be understood that padding may be performed when the data of the image is read into the first buffer or during the subsequent processing, which is not limited by the embodiments of the present disclosure.

In another embodiment, it may also be possible to only pad data to a part of the outer edge of the image, or not to pad the outer edge of the image. and then the column/row data at the edge of the image of the outer unpadded data may only be located in the R*R area. The unpadded columns and rows of data located at the outer edge of the image may only be located at the non-center position of the R*R area when the upsampling and filtering process is performed. If the number of columns of the image is W, N number of R*R areas may be obtained by omitting the R*R areas having data located on the outer edge of the R rows of data as the center, where N<M. M*W columns of M rows of processed data may be obtained by the N number of R*R areas and the number of columns of the M rows of processed data may be M*W.

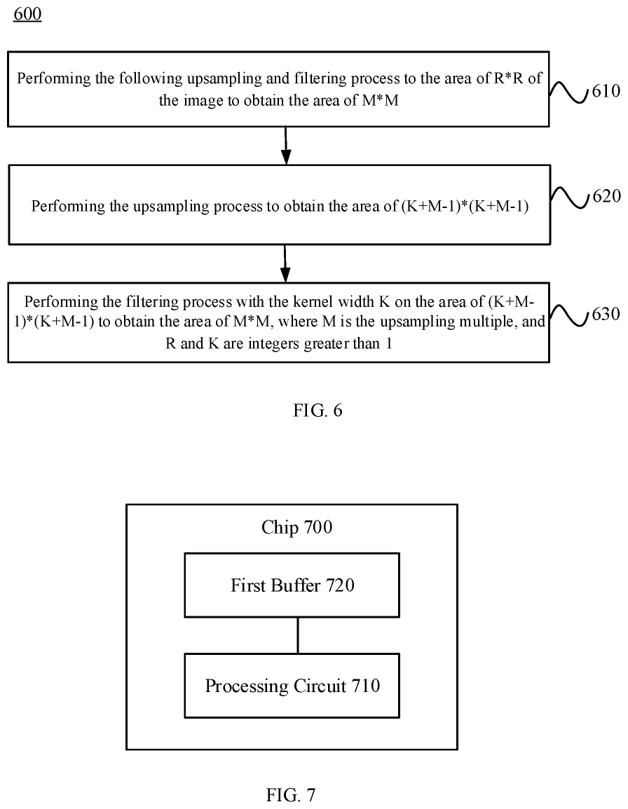

The technical solution provided in the embodiments of the present disclosure is described above using the row processing method, but the technical solution of the embodiments of the present disclosure is not limited thereto. That is, the processing of the R*R areas in the image mentioned in the embodiments of the present disclosure is not limited to row processing. Therefore, an embodiment of the present disclosure further provides another image processing method, which is described below in conjunction with FIG. 6. It should be understood that some specific descriptions of the method shown in FIG. 6 may refer to the foregoing embodiments, and are not described herein again for brevity.

FIG. 6 is a schematic flowchart of an image processing method 600 according to another embodiment of the present disclosure. As shown in FIG. 6, the method 600 may include the following steps:

Step 610, performing the following upsampling and filtering process to the area of R*R of the image to obtain the area of M*M.

Step 620, performing the upsampling process to obtain the area of (K+M−1)*(K+M−1).

Step 630, performing the filtering process with the kernel width K on the area of (K+M−1)*(K+M−1) to obtain the area of M*M, where M is the upsampling multiple, and R and K are integers greater than 1.

In one embodiment, performing the filtering process with the kernel width K on the area of (K+M−1)*(K+M−1) includes:

For each of the K*K areas in the M*M number of K*K areas in the area of (K+M−1)*(K+M−1), the filtering process with the kernel width of K may be performed to obtain a data in the M*M area, and M*M number of data of the M*M areas may be obtained by the M*M number of K*K areas. The selection of the K*K area may be performed by moving one row or one column, and the detail of which may be referred to the foregoing embodiments.

In one embodiment, the filtering process with the kernel width K includes:

Multiply each of the K*K areas by a corresponding element in the K*K filter matrix and sum them up.

In one embodiment, the upsampling process may include a linear interpolation or a bicubic interpolation. Of course, other interpolation methods may also be used in the upsampling process, and no limitation is imposed here.

In one embodiment, after performing the upsampling and filtering process on the R*R area, performing the upsampling and filtering process on the next R*R area to obtain the next M*M area, where the next R*R area may include the last R−1 columns of the R*R area and R number of data of the next column adjacent to the R*R area.

More specifically, the upsampling and filtering process may be performed on each R*R area. In particular, the selection of the R*R area may be performed by moving one column, that is, after processing the previous R*R area, move one column to obtain the next R*R area and perform the same process. It should be understood that the selection of the R*R area may also be performed by moving one row, that is, after processing the previous R*R area, move one row to obtain the next R*R area and perform the same process. Further, the selection method of the R*R area in the embodiments of the present invention is not limited.

In one embodiment, the R rows of data of the image may be read into the first buffer. In particular, M rows of processed data may be obtained after performing the upsampling and filtering process on each of the R*R areas of the R rows of data in the first buffer.

After processing the R rows of data, the next row of data of the image may be read into the first buffer. In particular, the next row of data and the original R−1 rows of data in the first buffer may be used as the R rows of data for the next upsampling and filtering process.

In one embodiment, the first row of the processed data of the M rows of processed data may be outputted and the second to Mth rows of the M rows of processed data may be buffered into the second buffer.

Further, after the first row of the processed data is outputted, the second to Mth rows of processed data may be sequentially outputted from the second buffer.

Furthermore, the next row of data of the image may be read into the first buffer after the Mth row of the processed data of the M rows of processed data is outputted.

In one embodiment, if the number of columns of the image is W, then the outer edges of the R rows of data may be padded to obtain W number of R*R areas, and M*W columns of M rows of processed data may be obtained by the W number of R*R areas.

In one embodiment, If the number of columns of the image is W, N number of R*R areas may be obtained by omitting the data located on the edge of the R rows of data, where N<M and M*W columns of M rows of processed data may be obtained by the N number of R*R areas.

In one embodiment, the M may be 2.

For the sake of brevity, the method for processing the R rows of data may be referred to the foregoing embodiments.

The image processing method provided in the embodiments of the present disclosure has been described in detail above. The chip, processor, computer system, and mobile device provided in the embodiments of the present disclosure will be described below. It should be understood that the chip, processor, computer system, and mobile device provided in the embodiments of the present disclosure may perform the various methods mentioned in the previous embodiments of the present disclosure. That is, for the specific working process of the following various products, reference may be made to the corresponding process in the foregoing method embodiments.

FIG. 7 is a schematic block diagram of a chip 700 according to an embodiment of the present disclosure. As shown in FIG. 7, the chip 700 may include a processing circuit 710 and a first buffer 720.

The processing circuit 710 may be used to read the R rows of data of the image into the first buffer 720, where R may be an integer greater than 1; perform the upsampling and filtering process to the R rows of data to obtain M rows of processed data, where M may be the upsampling multiple used in the upsampling and filtering process and M may be an integer greater than 1; and read the next row of data of the image into the first buffer 720 after processing the R rows of data, where the next row of data and the original R−1 rows of data in the first buffer 720 may be used as the R rows of data for the next upsampling and filtering process.

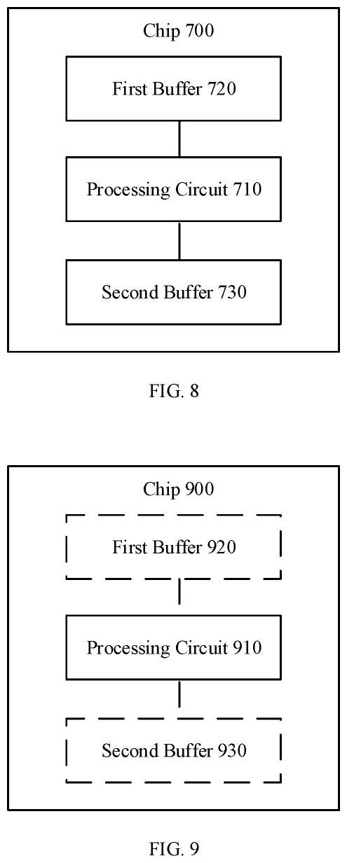

In some embodiments, as shown in FIG. 8, the chip 700 may further include a second buffer 730. In particular, the processing circuit 710 may also be used to output the first row of the processed data of the M rows of processed data and buffer the second to Mth rows of processed data of the M rows of processed data into the second buffer 730. Further, the processing circuit 710 may also be used to sequentially output the second to Mth rows of processed data of the M rows of processed data from the second buffer 730 after the first row of the processed data is outputted. Furthermore, the processing circuit 710 may also be used to read the next row of data of the image into the first buffer 720 after the Mth row of the processed data of the M rows of processed data is outputted.

In one embodiment, the R may satisfy the following condition: an area of (K+M−1)*(K+M−1) may be obtained after upsampling an area of R*R of the R rows of data with M multiple, where K may be the filter kernel width in the upsampling and filtering process.

In one embodiment, the processing circuit 710 may be used to sequentially perform the following process on each of the R*R areas of the R rows of data:

Performing the upsampling process on each of the R*R areas to obtain the area of (K+M−1)*(K+M−1).

Performing the filtering process with the kernel width K on the area of (K+M−1)*(K+M−1) to obtain the area of M*M, where the area of M*M may be the M column of the M rows of processed data.

In one embodiment, if the number of columns of the image is W, then the outer edges of the R rows of data may be padded to obtain W number of R*R areas, and M*W columns of M rows of processed data may be obtained by the W number of R*R areas.

In one embodiment, If the number of columns of the image is W, N number of R*R areas may be obtained by omitting the data located on the edge of the R rows of data, where N<M and M*W columns of M rows of processed data may be obtained by the N number of R*R areas.

In one embodiment, the processing circuit 710 may be used to perform the filtering process with the kernel width of K to obtain a data in the M*M area for each of the K*K areas in the M*M number of K*K areas in the area of (K+M−1)*(K+M−1), and obtain M*M number of data of the M*M areas by the M*M number of K*K areas.

In one embodiment, the processing circuit 710 may be used to multiply each of the K*K areas by a corresponding element in the K*K filter matrix and sum them up to obtain the data for the area of M*M.

In one embodiment, the processing circuit 710 may be used to obtain the area of (K+M−1)*(K+M−1) by linear interpolation or bicubic interpolation.

In one embodiment, the M may be 2.

FIG. 9 is a schematic block diagram of a chip 900 according to yet another embodiment of the present disclosure. As shown in FIG. 9, the chip 900 includes a processing circuit 910.

The processing circuit 910 may be used to perform the following upsampling and filtering process to the area of R*R of the image to obtain the area of M*M:

Performing the upsampling process to obtain the area of (K+M−1)*(K+M−1).

Performing the filtering process with the kernel width K on the area of (K+M−1)*(K+M−1) to obtain the area of M*M, where M is the upsampling multiple, and R and K are integers greater than 1.

In one embodiment, the processing circuit 910 may be used to perform the filtering process with the kernel width of K to obtain a data in the M*M area for each of the K*K areas in the M*M number of K*K areas in the area of (K+M−1)*(K+M−1), and obtain M*M number of data of the M*M areas by the M*M number of K*K areas.

In one embodiment, the processing circuit 910 may be used to multiply each of the K*K areas by a corresponding element in the K*K filter matrix and sum them up.

In one embodiment, the processing circuit 910 may be used to obtain the area of (K+M−1)*(K+M−1) by linear interpolation or bicubic interpolation.

In one embodiment, the processing circuit 910 may be used to perform the upsampling and filtering process on the next R*R area to obtain the next M*M area after performing the upsampling and filtering process on the R*R area, where the next R*R area may include the last R−1 columns of the R*R area and R number of data of the next column adjacent to the R*R area.

In one embodiment, the chip 900 may further include a first buffer 920.

In one embodiment, the processing circuit 910 may be used to read the R rows of data of the image into the first buffer 920. In particular, M rows of processed data may be obtained after performing the upsampling and filtering process on each of the R*R areas of the R rows of data in the first buffer 920.

Further, the processing circuit 910 may be used to read the next row of data of the image into the first buffer 920 after processing the R rows of data, where the next row of data and the original R−1 rows of data in the first buffer 920 may be used as the R rows of data for the next upsampling and filtering process.

In one embodiment, the chip 900 may further include a second buffer 930.

In some embodiments, the chip 700 may further include a second buffer 930. In particular, the processing circuit 910 may also be used to output the first row of the processed data of the M rows of processed data and buffer the second to Mth rows of processed data of the M rows of processed data into the second buffer 930. Further, the processing circuit 910 may also be used to sequentially output the second to Mth rows of processed data of the M rows of processed data from the second buffer 930 after the first row of the processed data is outputted. Furthermore, the processing circuit 910 may also be used to read the next row of data of the image into the first buffer 920 after the Mth row of the processed data of the M rows of processed data is outputted.

In one embodiment, if the number of columns of the image is W, then the outer edges of the R rows of data may be padded to obtain W number of R*R areas, and M*W columns of M rows of processed data may be obtained by the W number of R*R areas.

In one embodiment, If the number of columns of the image is W, N number of R*R areas may be obtained by omitting the data located on the edge of the R rows of data, where N<M and M*W columns of M rows of processed data may be obtained by the N number of R*R areas.

In one embodiment, the M may be 2.

It should be understood that the chip mentioned in the various embodiments of the present disclosure described above, the processing circuit may further include an input circuit, an upsampling and filtering circuit, and an output circuit. In particular, the input circuit may be used to read the data of the image into the first buffer, the upsampling and filtering circuit may be used to read the data in the first buffer to perform the upsampling and filtering process, and the output circuit may be used to output the processing result. In other words, the processing circuit may be a unified processing circuit, or a circuit composed of the above several circuits. The specific implementation form of the circuit is not limited in the embodiments of the present invention.

It should also be understood that the chip mentioned in the embodiments of the present disclosure may also include only the upsampling and filtering circuit, which may be used to perform the upsampling and filtering process mentioned in the above embodiments of the present disclosure, and other processes and buffering may be implemented by another chip.

An embodiment of the present disclosure further provides a processor, which may include the chip of the foregoing various embodiments of the present disclosure.

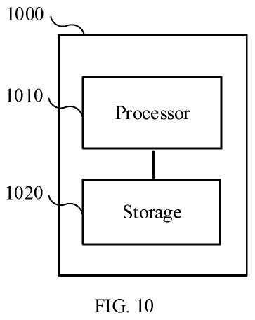

FIG. 10 is a schematic block diagram of a computer system 1000 according to an embodiment of the present disclosure.

As shown in FIG. 10, the computer system 1000 may include a processor 1010 and a storage 1020.

It should be understood that the computer system 1000 may further include components that are generally included in other computer systems, such as an input device, an output device, a communication interface, and the like, which are not limited by the embodiments of the present disclosure.

In particular, the storage 1020 may be used to store computer executable instructions.

The storage 1020 may be various types of storages, for example, it may include a high speed Random Access Memory (RAM), and it may also include a non-volatile memory, such as one or more disk memories, which is not limited by the embodiments of the present disclosure.

The processor 1010 may be used to access the storage 1020 and execute the computer executable instructions to perform the steps in the image processing method of the various embodiments of the present disclosure described above.

The processor 1010 may include a microprocessor, a Field-Programmable Gate Array (FPGA), a Central Processing Unit (CPU), a Graphics Processing Unit (GPU), etc., which is not limited by the embodiments of the present disclosure.

An embodiment of the present disclosure also provides a mobile device, which may include the chip, processor or computer system of the various embodiments of the present disclosure described above.

The chip, processor, computer system, and mobile device in the embodiments of the present disclosure may correspond to an execution body of the image processing method of the embodiments of the present disclosure. Further, the abovementioned and other operations and functions of the respective modules in the chip process, computer system, and mobile device are respectively implemented in order to implement the corresponding processes of the foregoing various methods. For brevity, no further details are provided herein.

An embodiment of the present disclosure further provides a computer storage medium. The computer storage medium may be used to store computer executable instructions, and the computer executable instructions may be used to indicate a method for transmitting the encoded data according to the embodiments of the disclosure.

It should be understood that, the term “and/or” in this specification describes only an association relationship for describing associated objects and represents that three relationships may exist. For example, A and/or B may represent the following three cases, only A exists, both A and B exist, and only B exists. In addition, the character “/” in this specification generally indicates an “or” relationship between the associated objects.

Persons skilled in the art may further realize that, units and steps of algorithms according to the description of the embodiments disclosed by the present invention can be implemented by electronic hardware, computer software, or a combination of the two. In order to describe interchangeability of hardware and software clearly, compositions and steps of the embodiments are generally described according to functions in the forgoing description. Whether these functions are executed by hardware or software depends upon specific applications and design constraints of the technical solutions. Persons skilled in the art may use different methods for each specific application to implement the described functions, and such implementation should not be construed as a departure from the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be omitted or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The software product is stored in a storage medium and includes several instructions for instructing a computer device (which may be a personal computer, a server, or a network device) or a processor to perform all or some of the steps of the methods described in the embodiments of the present application. The foregoing storage medium includes: any medium that can store program code, such as a universal serial bus (USB) flash drive, a removable hard disk, a read-only memory (ROM), a random-access memory (RAM), a magnetic disk, an optical disc, etc.

As discussed above, the foregoing embodiments are only used to describe the technical solutions of the present application in detail. However, the description of the foregoing embodiments is only used to help to understand the method of the present disclosure and the core concept thereof, and should not be construed as a limitation to the present disclosure. Any variation or replacement readily figured out by a person skilled in the art within the technical scope disclosed in the present disclosure shall fall within the protection scope of the present disclosure.

As discussed above, the foregoing embodiments are only used to describe the technical solutions of the present application in detail. However, the description of the foregoing embodiments is only used to help to understand the method of the present disclosure and the core concept thereof, and should not be construed as a limitation to the present disclosure. Any variation or replacement readily figured out by a person skilled in the art within the technical scope disclosed in the present disclosure shall fall within the protection scope of the present disclosure. Therefore, the scope of protection of the present disclosure should be determined by the scope of the claims.

What is claimed is:

1. An image processing method, comprising:
reading R rows of data of the image into a first storage buffer, R is an integer greater than 1;
upsampling and filtering the R rows of data to obtain M rows of processed data, M is the upsampling multiple in the upsampling and filtering process, and M is an integer greater than 1;
reading a next row of data of the image into the first storage buffer after processing the R rows of data, the next row of data and the original R−1 rows of data in the first storage buffer are used as the R rows of data for the next upsampling and filtering process; and
outputting the M rows of processed data.

2. The method of claim 1, further comprising:
outputting a first row of the processed data of the M rows of processed data and buffering a second row of the M rows of processed data into a second storage buffer;
sequentially outputting the second to Mth rows of the processed data after outputting the first row of the processed data; and,
reading the next row of data of the image into the first storage buffer after outputting the Mth row of the processed data of the M rows of processed data.

3. The method of claim 1, wherein an area of (K+M−1)*(K+M−1) is obtained after upsampling an area of R*R of the R rows of data with the M multiple, K being a filter kernel width in the upsampling and filtering process.

4. The method of claim 3, wherein performing the upsampling and filtering process on the R rows of data includes:
upsampling each of the R*R areas to obtain the area of (K+M−1)*(K+M−1); and,
filtering with the kernel width of K on the area of (K+M−1)*(K+M−1) to obtain an area of M*M, the area of M*M being the M column of the M rows of processed data.

5. The method of claim 4, wherein: the number of columns of the image is W, a plurality of outer edges of the R rows of data is padded to obtain W number of R*R areas, and M*W columns of M rows of processed data is obtained based on the W number of R*R areas.

6. The method of claim 4, wherein: the number of columns of the image is W, N number of R*R areas is obtained by omitting the data located on the edges of the R rows of data, where N<M, and M*N columns of M rows of processed data is obtained based on the N number of R*R areas.

7. The method of claim 4, filtering with the kernel width of K on the area of (K+M−1)*(K+M−1) further comprising:
filtering with the kernel width of K to obtain a data in the M*M area for each of the K*K areas in the M*M number of K*K areas in the area of (K+M−1)*(K+M−1), and obtaining M*M number of data of the M*M areas by the M*M number of K*K areas.

8. The method of claim 7, wherein filtering with the kernel width of K further comprising:
multiplying each data element in the K*K areas by a corresponding element in the K*K filter matrix to obtain a sum.

9. A chip, comprising a processing circuit and a first storage buffer, wherein the processing circuit is configured to perform:
reading R rows of data of the image into the first storage buffer, R is an integer greater than 1;
upsampling and filtering the R rows of data to obtain M rows of processed data, M is the upsampling multiple in the upsampling and filtering process, and M is an integer greater than 1;
reading a next row of data of the image into the first storage buffer after processing the R rows of data, the next row of data and the original R−1 rows of data in the first storage buffer are used as the R rows of data for the next upsampling and filtering process; and
outputting the M rows of processed data.

10. The chip of claim 9, further comprising a second storage buffer, wherein the processing circuit is configured to perform:
outputting a first row of the processed data of the M rows of processed data and buffering the a second to Mth rows of the processed data of the M rows of processed data into the second storage buffer;
sequentially outputting the second to Mth rows of the processed data after outputting the first row of the processed data; and,
reading the next row of data of the image into the first storage buffer after outputting the Mth row of the processed data of the M rows of processed data.

11. The chip of claim 9, wherein an area of (K+M−1)*(K+M−1) is obtained after upsampling an area of R*R of the R rows of data with M multiple, where K is a filter kernel width in the upsampling and filtering process.

12. The chip of claim 11, wherein the processing circuit is further configured to perform:
upsampling each of the R*R areas to obtain the area of (K+M−1)*(K+M−1); and,
filtering with the kernel width of K on the area of (K+M−1)*(K+M−1) to obtain an area of M*M, where the area of M*M is the M column of the M rows of processed data.

13. The chip of claim 12, wherein the number of columns of the image is W, a plurality of outer edges of the R rows of data is padded to obtain W number of R*R areas, and M*W columns of M rows of processed data is obtained by the W number of R*R areas.

14. The chip of claim 12, wherein the number of columns of the image is W, N number of R*R areas is obtained by omitting the data located on the edges of the R rows of data, where N<M, and M*N columns of M rows of processed data is obtained by the N number of R*R areas.

15. The chip of claim 12, wherein the processing circuit is further configured to perform:
filtering with the kernel width of K to obtain a data in the M*M area for each of the K*K areas in the M*M number of K*K areas in the area of (K+M−1)*(K+M−1), and obtaining M*M number of data of the M*M areas by the M*M number of K*K areas.

16. An image processing method for an image of R*R, comprising:
upsampling to obtain an area of (K+M−1)*(K+M−1), K being a kernel width;
filtering with the kernel width of K on the area of (K+M−1)*(K+M−1) to obtain an area of M*M, wherein R, M, and K are integers greater than 1; and
outputting the area of M*M.

17. The method of claim 16, wherein filtering with the kernel width of K on the area of (K+M−1)*(K+M−1) includes:
filtering with the kernel width of K to obtain a data in the M*M area for each of the K*K areas in the M*M number of K*K areas in the area of (K+M−1)*(K+M−1), and obtaining M*M number of data of the M*M areas by the M*M number of K*K areas.

18. The method of claim 16, wherein filtering with the kernel width of K includes:
multiplying each data element in the K*K areas by a corresponding element in the K*K filter matrix to obtain a sum.

19. The method of claim 16, wherein the upsampling process includes a linearly interpolation or a bicubic interpolation.

20. The method of claim 16, further comprising:
upsampling and filtering a next R*R area to obtain the next M*M area after performing the upsampling and filtering process on the R*R area, the next R*R area includes the last R−1 columns of the R*R area and R number of data of the next column adjacent to the R*R area.
